(19) United States
(12) Patent Application Publication
(10) Pub. No.: US 2003/0120814 A1
(43) Pub. Date: Jun. 26, 2003

(54) Transmission method for a compressible datafile

(75) Inventor: Holger Dresel, Altendorf (DE)

Correspondence Address: SCHIFF HARDIN & WAITE, 6600 SEARS TOWER, 233 S WACKER DR, CHICAGO, IL, 60606-6473, US

(73) Assignee: Siemens Aktiengesellschaft

(21) Appl. No.: 10/313,315

(22) Filed: Dec. 6, 2002

(30) Foreign Application Priority Data
Dec. 21, 2001 (DE) 10163468.4

(51) Int. Cl. G06F 15/16

(52) U.S. Cl. 709/247

(57) ABSTRACT

A transmission request for a compressible datafile is transmitted to a server from a client. The server transmits the compressible datafile or a corresponding, compressed compact datafile to the client dependent on whether the client also provided it with a compress command. The client receives the transmitted datafile and checks which of the two datafiles has been transmitted to it. When the compact datafile has been transmitted, then the client automatically decompresses it.

### BACKGROUND OF THE INVENTION

1. Field of the Invention

The present invention is directed to a transmission method for a compressible datafile, particularly a text datafile, for example an html datafile, from a server to a client via a transmission link.

2. Description of the Prior Art

Transmission methods of the above type are well known. As a rule, the client transmits a transmission request to the server. The server then transmits the compressible datafile to the client. This leads to long transmission times in the case of large compressible datafiles. This is especially true when the transmission link is fashioned as an ISDN or as a modem connection. Such connections exhibit a relatively low transmission bandwidth.

The Internet sites http://www.w3.org/Protocols/HTTP/Performance/Compression/LAN.html and -PPP.html disclose compression of html datafiles and transmission compressed from the server to the client. A decompression then ensues at the client side.

The Internet sites provide no indication of the conditions under which a transmission of html pages from the server to the client should ensue compressed and should ensue uncompressed.

### SUMMARY OF THE INVENTION

An object of the present invention is to make transmission methods between the server and the client available with which a proper communication is always possible between the server and the client regardless of whether the server and/or the client support a compressed transmission of datafiles.

This object is achieved at the server side by a transmission method wherein the server checks whether a compress command was communicated to it from the client and automatically transmits a compact datafile that corresponds to the compressible datafile and is compressed compared thereto, to the client via the transmission link only when a compress command has been communicated, and otherwise transmits the compressible datafile to the client via the transmission link.

Corresponding thereto, the object is achieved at the client side by a communication method wherein the client communicates a compress command to the server in addition to the transmission request for the compressible datafile, wherein the client receives a datafile transmitted from the server on the basis of the transmission request, wherein the client automatically checks whether the communicated datafile is the compressible datafile or a compact datafile that corresponds to the compressible datafile and is compressed compared thereto, and wherein the client, given transmission of the compact datafile, automatically decompresses the data file.

A compression-compatible server thus transmits the compact datafile only when the client requests it. Conversely, the client always checks whether it has received the compact datafile or the compressible datafile. The server as well as the client thus also communicate properly with one another when the server cannot make the compact datafile available or if the client may not be able to decompress the compact datafile.

It is possible that both the compressible datafile as well as the compact datafile are stored in advance in the server, and the server selects the datafile to be transmitted on the basis of the transmission request dependent on the transmission or non-transmission of the compress command. Transmissions then can ensue especially fast. This procedure is particularly meaningful when the compressible datafile is time-stable, i.e. is not modified or is only rarely modified.

Alternatively, it is possible that only the compressible datafile is stored in the server in advance, and the server only generates the compact datafile after the transmission of the transmission request. This procedure requires only slight modifications at existing servers. In this case only the operating software itself need be modified.

Alternatively, it is possible that only the compact datafile is stored in the server in advance, and, given non-transmission of the compress command, the server generates the compressible datafile only after the transmission of the transmission request. This procedure requires especially little memory capacity since the datafiles have to be stored in the server in compressed form.

It is also possible that neither the compressible datafile nor the compact datafile is stored in the server in advance, and the server generates the compressible datafile and/or the compact datafile on the basis of data blocks deposited in servers only after the transmission of the transmission request.

The transmission link can be fashioned, for example, as LAN or can contain a point-to-point connection, for example an ISDN connection, a DSL connection or a modem connection. An especially large time-saving in the transmission of the compact datafile is achieved by the use of a modem.

Alternatively, the compress command can be communicated to the server together with the transmission request, or in advance.

When the server communicates a datafile identifier—on the basis of which the client can check whether the communicated datafile is the compressible datafile or the compact datafile—to the client together with the transmitted datafile, then the client can determine without difficulty whether it is being sent the compact datafile or the compressible datafile. When, for example, the transmission ensues according to the http, then the datafile identifier can be transmitted, for example, in the framework of a MIME type.

The server can be operated in an especially flexible way when an operator prescribes a server control parameter to the server, and the compact datafile is communicated to the client only given the prescribed server control parameter and the compressible datafile is always transmitted to the client otherwise.

Preferably, the client immediately further-processes the compressible datafile after the transmission or decompression. In particular, the further-processing can be an interactive presentation of the compressible datafile on a viewing device or a storage of the compressible datafile on a non-volatile storage medium, for example a hard disk.

The client also can be utilized in an especially flexible way when a user prescribes a client control parameter to the client, and the client communicates the compress command to the server only given the prescribed client control parameter.

### DESCRIPTION OF THE DRAWINGS

FIG. 1 illustrates a server and a client that are connected to one another via a transmission link.

FIGS. 2 through 6 are flowcharts explaining the inventive method.

### DESCRIPTION OF THE PREFERRED EMBODIMENTS

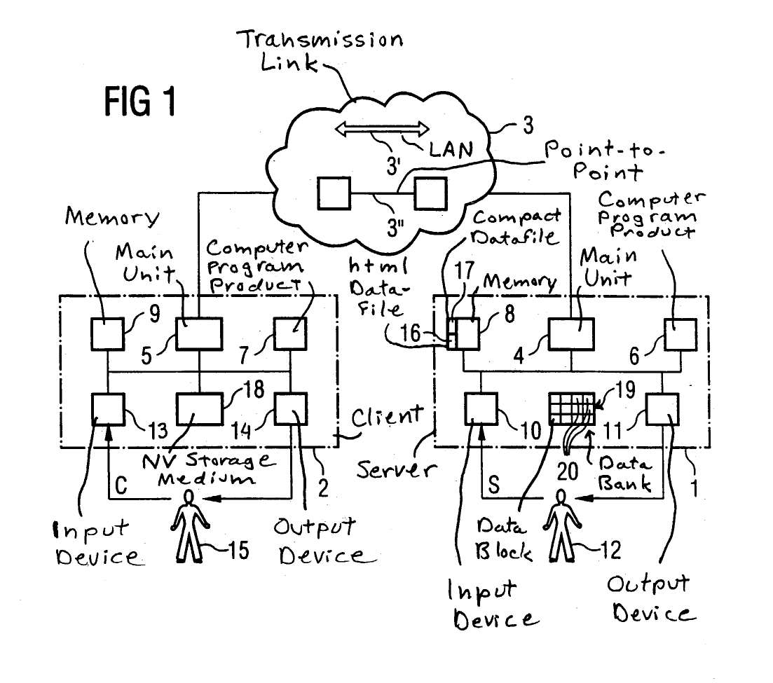

As shown in FIG. 1, a server 1 and a client 2 are connected to one another via a transmission link 3. As schematically indicated in FIG. 1, the transmission link 3 can be fashioned as a LAN 3′ or can contain a point-to-point connection 3″, for example a modem connection 3″. The server preferably is a web server for the Internet.

The server 1 as well as the client 2 each has a main unit 4, 5. The main units 4, 5 run computer program products 6, 7 with which the server 1 or the client 2 are programmed. The computer program product 7 of the client 2 preferably includes the functionality of an Internet browser such as, for example, Internet Explorer or Netscape.

When running the computer program products 6, 7, the main units 4, 5 among other things—access memories 8, 9. The server 1 and the client 2 also communicate with one another. From time to time, the server 1 also communicates interactively with an operator 12 via an input device 10 and an output device 11, for example in the framework of configuration and maintenance tasks. The client 2 communicates with a user 15 via an input device 13 and an output device 14. The input devices 10, 13 typically have a keyboard and a mouse control; the output devices 11, 14 typically have a monitor or a similar viewing device.

A number of html datafiles, i.e. specific text datafiles, are stored in the memory 8 of the server 1. For clarity, only one such html datafile 16 is shown in FIG. 1. Compact datafiles corresponding to the html datafiles are also stored in the memory 8. Here, as well, only one compact datafile 17 is shown in FIG. 1 for clarity. The compact datafiles correspond to their text datafiles but are compressed independently of transmission link compared to them.

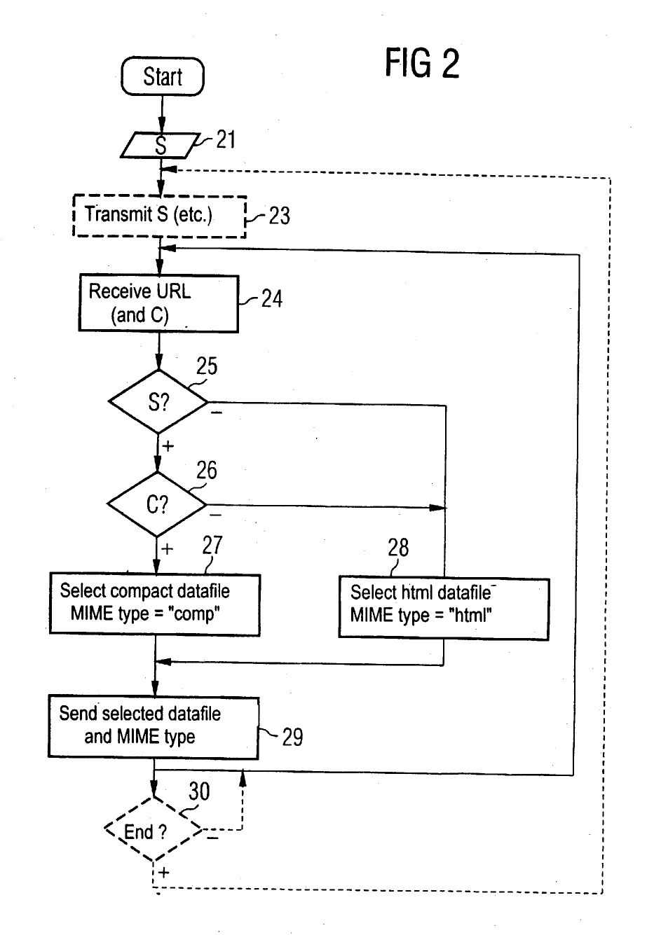

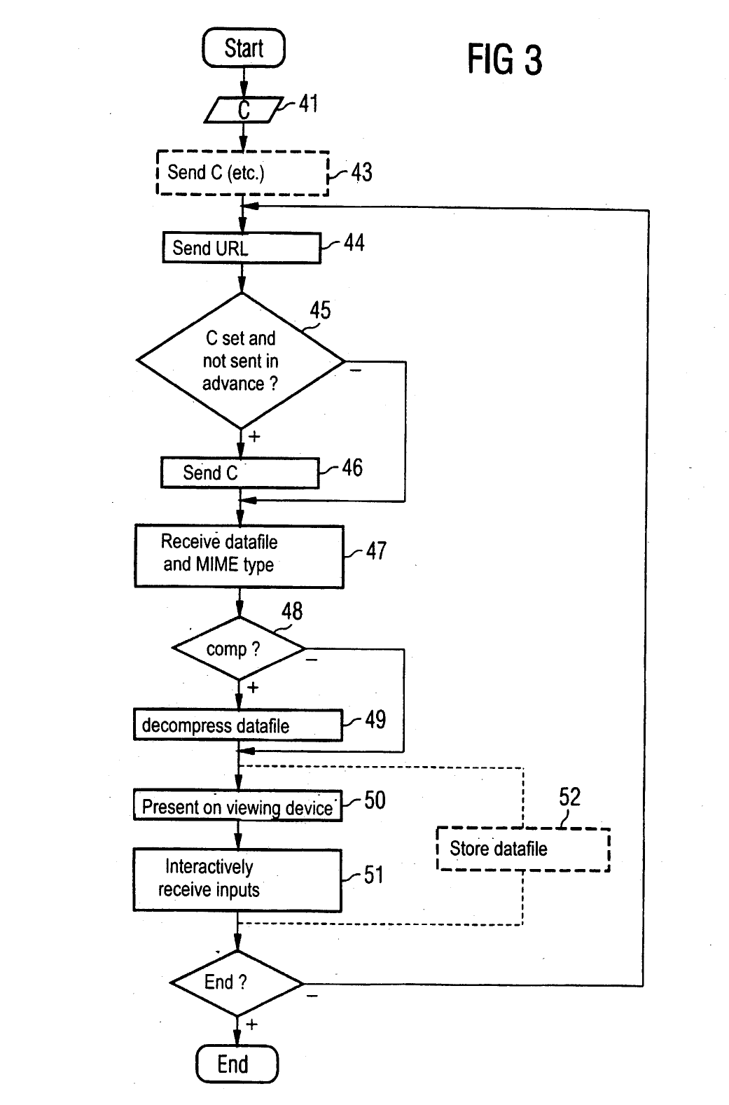

Upon initial running of its computer program product 6, i.e. in the framework of the configuration and/or installation, the server 1—according to FIG. 2—first inquires of the operator 12 in a step 21 whether a server control parameter is being prescribed for it. When running its computer program product 7, the client 2—according to FIG. 3—analogously inquires of the user 15 in a step 41 whether a client control parameter C is being prescribed for it. The client control parameter C can have different meanings. In particular, it is possible for the control parameter C to indicate that it defines that the client 2 supports the compressed transmission of html datafiles.

Subsequently, both computers 1, 2 wait until the user 15 requests a datafile at the server 1 by providing an appropriate command at the client 2. The server 1 thus waits for a transmission of a transmission request (for example, a URL address), and the client 2 waits for the user 15 to enter a corresponding request preference.

When the user 15 informs the client 2 of a desired request, then the client 2 communicates a corresponding transmission request to the server 1 in a step 44. In a step 45, the client 2 then checks whether the client control parameter C was set. If yes, the client control parameter C is also communicated to the server in a step 46. The transmission of the compress command C thus ensues together with the transmission of the transmission request, for example as an add-on to a communicated URL.

The server 1 receives the transmission request (and, possibly, the client control parameter C as well) in a step 24. In a step 25, it first automatically checks whether the server control parameter S is set. Only when this is the case does it automatically check in a further step 26 whether it has received the client control parameter C. A step 27 is implemented when the server control parameter S has been prescribed and the client control parameter C also has been transmitted to the server; otherwise, a step 28 is implemented.

In step 27, the server 1 automatically selects the compact datafile 17 as the datafile to be sent to the client 2. It also sets the type “compressed” as the MIME type to be transmitted. If the step 28 is implemented, the server automatically selects the html datafile 16 as the datafile to be transmitted and the type “html” as the MIME type. In both instances, the datafile 16 or 17 to be transmitted and the type allocated thereto are then transmitted from the server 1 to the client 2 in a step 29. A branch is then made back to the step 24.

As a result, thus, the server 1 transmits the compact datafile 17 when the server 1 was provided with the server control parameter S and a compress command C in the form of the client control parameter C was communicated to it. Of course, the client 2 communicates the client control parameter C to the server 1 only when the client 2 was likewise provided with the client control parameter C.

It is possible to re-query the client control parameter C at the user 15 at every call of the computer program product 7, however, it is preferably accepted as a setting and is stored, so that it is available without further difficulty given later calls.

The client 2 receives the transmitted datafile 16, 17 and the datafile identifier allocated to it (given transmission according to http, thus, the MIME type) in a step 47. On the basis of the datafile identifier, i.e. on the basis of the communicated datafile type, the client 2 then automatically checks in a step 48 as to whether the transmitted datafile 16, 17 is the html datafile 16 or the compact datafile 17. When the type “compressed” is communicated to it as datafile type, then the client 2 automatically decompresses the compact datafile 17 in a step 49.

The datafile 16 that was either directly transmitted or recovered by decompression is immediately further-processed by the client 2 after the transmission or, respectively, decompression. As a rule, this ensues by means of a presentation at a viewing device of the output device 14 according to a step 50. The user 15 then can direct interactive inputs to the client 2 in a step 51. The presentation of the transmitted html datafile 16 is thus interactive. Alternatively or additionally, it is possible to directly store the text datafile 16 on a non-volatile storage medium 18 in a step 52 (indicated with broken lines). As shown in FIG. 1, the non-volatile storage medium 18 is a hard disk 18 but could also be some other storage medium, for example a diskette.

If the client program 7 is not to be ended then, a branch is made back to the step 44.

In the above-described procedure, the client 2 transmits the compress command C to the server together with the transmission request every single time. Given a communication according to http, this usually cannot be done in any other way. In other communication modes, however, it may be possible for the client 2 to communicate the compress command C to the server 1 in advance. This is also indicated with broken lines in steps 23 and 43 in FIGS. 2 and 3. As likewise indicated with broken lines in FIG. 2, a step 30 wherein a check is performed to determine whether the communication between the server 1 and the client 2 is to be ended is implemented after the step 29. Dependent on the result of this step, a branch is made either to step 24 or to step 23.

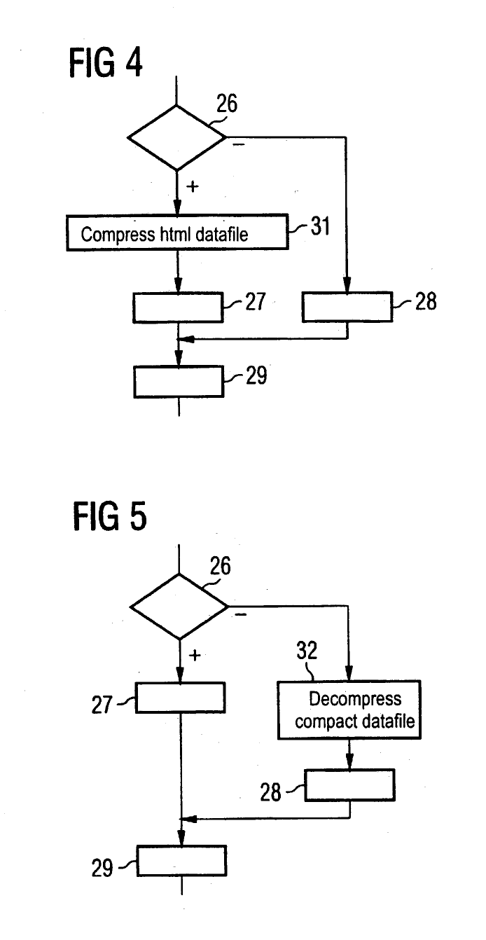

It was assumed in the embodiment according to FIGS. 2 and 3 that both the html datafile 16 as well as the compact datafile 17 are stored in advance in the server 1. The only thing required in this case is that the server 1 selects the datafile 16 or, respectively, 17 to be transmitted dependent on the transmission or non-transmission of the compress command and whether the server control parameter S was provided or not provided. However, it also suffices when only one of the two datafiles 16, 17 is stored in the memory 8. This is explained in greater detail below in conjunction with FIGS. 4 and 5.

It is assumed in the embodiment according to FIG. 4 that only the html datafile 16 is stored in advance in the server 1. In this case, a compression of the requested html datafile 16 is implemented in a step 31 preceding the step 27. In step 31, thus, the server 1 does not generate the compact datafile 17 until after the transmission of the transmission request.

Conversely, it is assumed in the embodiment according to FIG. 5, that only the compact datafile 17 is stored in advance in the server 1. In this case, the html datafile 16 is first generated on the basis of the stored compact datafile 17 in a step 32 preceding the execution of the step 28. In this case, as well, the html datafile 16 is not generated until after the transmission of the transmission request.

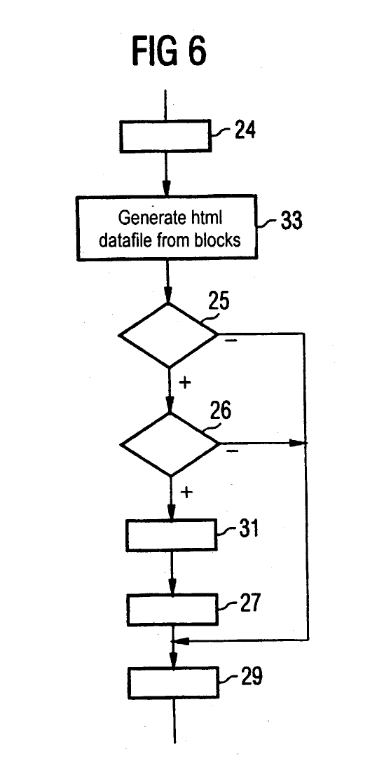

It can even suffice for neither of the two datafiles 16, 17 to be deposited in advance in the memory 8. In this case, however, data blocks 20—for example, in the form of a databank 19—are stored in the server 1. According to FIG. 6, the server 1 first executes a step 33 in this case after receiving a transmission request in the step 24. The text datafile 16 is generated in this step 33 on the basis of the stored data blocks 20. The remaining sequence then ensues as described above in conjunction with FIG. 4.

In the embodiment according to FIG. 6, thus, the text datafile 16 is always generated, but the compact datafile 17 is generated only when the transmission of the compact datafile 17 was requested. However, it is also possible to generate the compact datafile 17 directly on the basis of the data blocks 20, i.e. without previously generating the text datafile 16.

If not only html datafiles but also normal text datafiles are to be transmitted optionally compressed or non-compressed, then this can ensue in a completely analogous way. In this case, only a distinction in the MIME type need be made between the types “html” for html datafiles, “text” for text datafiles and “comp-html” and “comp-text” for the corresponding compact datafiles.

The above example of compressed transmission of text datafiles, of course, also can be transferred to other datafiles that are capable of compression. Examples of such datafiles are Word datafiles, Excel datafiles and others. These datafiles are themselves not compressed at all or at least are not highly compressed. An application of the above-described procedure is in fact possible but not meaningful given datafiles that are already self-compressed such as, for example, executable programs, JPG datafiles or GIF datafiles.

As a result of the above-described transmission method, it is assured at the server side as well as at the client side that a proper communication between server 1 and client 2 occurs. This is true regardless of whether the other computer 2, 1 supports a transmission of compressed html datafiles. The computer program products 6, 7 can thereby be inherently uniform computer program products 6, 7. It is also possible, however, to link corresponding auxiliary functions to existing programs, for example a supplementary program for a server 1 via suitable program links (in web servers, for example, ISAPI, ActiveServerPages or CGI programs, cookies) or for a client 2 by means of a corresponding client expansion (in Internet browsers, for example, PlugIns such as ActiveX, java programs, cookies).

Although modifications and changes may be suggested by those skilled in the art, it is the intention of the inventor to embody within the patent warranted hereon all changes and modifications as reasonably and properly come within the scope of his contribution to the art.

I claim as my invention:

1. A transmission method for a compressible datafile, comprising the steps of:
establishing a transmission link between a server and a client;
transmitting a request for a compressible datafile via said transmission link from said client to said server;
at said server, checking whether a compress command was transmitted with said transmission request; and
if said compress command has been transmitted, automatically transmitting a compact datafile, corresponding to said compressible datafile and being compressed relative to said compressible datafile, from said server to said client via said transmission link, and otherwise transmitting said compressible datafile to said client from said server via said transmission link.

2. A transmission method as claimed in claim 1 comprising storing said compressible datafile and said compact datafile in said server in advance of transmission of said transmission request, and at said server, selecting between said compressible datafile and said compact datafile for transmission to said client dependent on whether said compress command was transmitted from said client.

3. A transmission method as claimed in claim 1 comprising storing only said compressible datafile at said server in advance of transmission of said transmission request, and generating said compact datafile in said server from said compressible datafile only after transmission of said transmission request.

4. A transmission method as claimed in claim 1 comprising storing only said compact datafile in said server in advance of transmission of said transmission request, and generating said compressible datafile at said server from said compact datafile only after transmission of said transmission request with no compress command.

5. A transmission method as claimed in claim 1 comprising operating said server with no storage of said compressible datafile therein and no storage of said compact datafile therein in advance of transmission of said transmission request, and generating said compact datafile at said server from data blocks stored in said server only after transmission of a transmission request with said compress command, and generating said compressible datafile at said server from data blocks stored in said server only after transmission of a transmission request with no compress command.

6. A transmission method as claimed in claim 1 wherein the step of establishing a transmission link comprises establishing a LAN transmission link.

7. A transmission method as claimed in claim 1 wherein the step of establishing a transmission link comprises establishing a point-to-point connection between said server and said client.

8. A transmission method as claimed in claim 1 comprising communicating said compress command from said client to said server together with said transmission request via said transmission link.

9. A transmission method as claimed in claim 1 comprising communicating said compress command from said client to said server via said transmission link in advance of transmission of said transmission request.

10. A transmission method as claimed in claim 1 comprising communicating a data identifier from said server to said client which identifies whether the datafile transmitted from said server to said client is said compressible datafile or said compact datafile.

11. A transmission method as claimed in claim 1 comprising checking at said server whether an operator-prescribed server control parameter has been entered into said server, and transmitting said compact datafile via said transmission link to said client only if said server control parameter has been entered into said server, and otherwise transmitting said compressible datafile from said server to said client via said transmission link.

12. A computer program product loadable into a server for causing said server to establish a transmission link with a client, receive a request for a compressible datafile via said transmission link from said client, check whether a compress command was transmitted with said transmission request, and if said compress command has been transmitted, to automatically transmit a compact datafile, corresponding to said compressible datafile and being compressed relative to said compressible datafile, to said client via said transmission link, and otherwise to transmit said compressible datafile to said client via said transmission link.

13. A server comprising a main computer unit programmed to establish a transmission link between a server and a client, receive a request for a compressible datafile via said transmission link from said client to said server, check whether a compress command was transmitted with said transmission request, and if said compress command has been transmitted, automatically transmitting a compact datafile, corresponding to said compressible datafile and being compressed relative to said compressible datafile, to said client via said transmission link, and otherwise to transmit said compressible datafile to said client via said transmission link.

14. A transmission method for a compressible datafile comprising:
establishing a transmission link between a server and a client;
transmitting a compress command from said client to said server via said transmission link associated with a request for a compressible datafile;
in response to said request, receiving a datafile via said transmission link at said client transmitted from said server;
at said client, automatically checking whether said datafile received at said client is said compressible datafile, or a compact datafile corresponding to said compressible datafile and being compressed relative to said compressible datafile; and
if said datafile received at said client is said compact datafile, automatically decompressing said compact datafile at said client.

15. A transmission method as claimed in claim 14 wherein the step of establishing a transmission link comprises establishing a LAN transmission link.

16. A transmission method as claimed in claim 14 wherein the step of establishing a transmission link comprises establishing a point-to-point connection between said client and said server.

17. A transmission method as claimed in claim 14 comprising transmitting said compress command together with said transmission request from said client to said server.

18. A transmission method as claimed in claim 14 comprising transmitting said compress command from client to said server in advance of said transmission request.

19. A transmission method as claimed in claim 14 comprising, at said client, receiving a datafile identifier from said server via said transmission link together with the datafile received at said client, and at said client checking said data identifier to determine whether said datafile received at said client is said compressible datafile or said compact datafile.

20. A transmission method as claimed in claim 14 comprising further processing said datafile received at said client immediately upon receipt thereof at said client if said datafile received at said client is said compressible datafile.

21. A transmission method as claimed in claim 20 comprising, in said further processing of said compressible datafile, interactively presenting said compressible datafile at a viewing device at said client.

22. A transmission method as claimed in claim 20 comprising in said further processing of said compressible datafile, storing said compressible datafile in a non-volatile storage medium at said client.

23. A transmission method as claimed in claim 14 comprising further processing said datafile received at said client immediately after decompression thereof, if said datafile received at said client is said compact datafile.

24. A transmission method as claimed in claim 23 comprising in said further processing of said datafile received at said client, interactively presenting said compact datafile, after decompression thereof, at a viewing device at said client.

25. A transmission method as claimed in claim 23 comprising, in said further processing of said datafile received at said client, storing said compact datafile, after decompression thereof, in a non-volatile storage medium at said client.

26. A transmission method as claimed in claim 14 comprising checking at said client whether an operator-prescribed control parameter has been entered into said client, and transmitting said compress command from said client to said server only if said client control parameter has been entered into said client.

27. A computer program loadable into a client for causing client to establish a transmission link with a server transmit a compress command to said server via said transmission link associated with a request for a compressible datafile, in response to said request, to receive a datafile via said transmission link transmitted from said server, to automatically check whether said datafile received at said client is said compressible datafile, or a compact datafile corresponding to said compressible datafile and being compressed relative to said compressible datafile, and if said datafile received at said client is said compact datafile, to automatically decompress said compact datafile at said client.

28. A client comprising a main computer unit programmed to establish a transmission link with a server, transmit a compress command to said server via said transmission link associated with a request for a compressible datafile, in response to said request, receive a datafile via said transmission link transmitted from said server automatically check whether said datafile received at said client is said compressible datafile, or a compact datafile corresponding to said compressible datafile and being compressed relative to said compressible datafile, and if said datafile received at said client is said compact datafile, to automatically decompress said compact datafile at said client.
